(19) United States
(12) Patent Application Publication
(10) Pub. No.: US 2010/0264144 A1
(43) Pub. Date: Oct. 21, 2010

(54) Closure with pouring means

(75) Inventors: Philippe Nusbaum, Daix (FR); Frédéric Granier, Brognon (FR)

Correspondence Address: HARNESS, DICKEY & PIERCE, P.L.C., P.O. BOX 828, BLOOMFIELD HILLS, MI, 48303, US

(73) Assignee: BERICAP, Longvic (FR)

(21) Appl. No.: 11/988,604

(22) PCT Filed: Jun. 30, 2006
(86) PCT No.: PCT/FR2206/001553

§ 371 Date: Jun. 23, 2010

(30) Foreign Application Priority Data
Jul. 12, 2005 (FR) 0552153

(51) Int. Cl. B65D 51/20; B29C 45/14

(52) U.S. Cl. 220/258.2; 220/259.1; 264/242

(57) ABSTRACT

The invention concerns a closure with pouring means comprising a first part including pouring means (4) and a base (3) having a skirt for being fixed to the body of the container and first rigid fixing means for a second part including a cap (6) having a top wall, a skirt (20) and sealing means (22) for the pouring means (4), means (7) for pivoting the cap (6) and second rigid fixing means complementary of the first rigid fixing means. The pivoting means (7), located transversely plumb over the skirt of the cap (6), comprise a globally hollow deformable part delimited by an upper arc-shaped segment of reduced thickness belonging to the skirt (20), by a lower arc-shaped segment of reduced thickness belonging to the second fixing means, and by two axially oriented free edges, such that when the stopper is opened, the pivoting angle of the cap may be of the order of 180°.

The invention relates to a cap provided with dispensing means. Such a cap is typically intended for containers (such as bottles) used for packaging a liquid or a pasty content and more particularly a food product such as oil, sauce, vinegar, dairy, or any other product.

Document EP-A-0 472 655 describes a cap comprising a dispensing body including a disc and a crown including a hinge. To manufacture such body, the dispensing body is obtained by molding by injection a flexible plastic material, the edge of the dispensing body having the shape of a dowel, then the crown is made in the open position, by an over-molding localized at the dowel, with a hard plastic material, the edge of the crown having a connection portion with the dowel. The dispensing body belongs to a collar having a skirt for fixation to the neck of the container and a belt placed outside, where the dowel is. The crown includes a sealing internal skirt and an external skirt having, on its edge, the hinge, close to the connection portion. The hinge, which provides the closed position and, at approximately 135°, an opening position, is substantially located in the plane of the external joint of the dispensing body and of the crown and it is axially separated from the edge of the sealing skirt. The cap may include, opposite the hinge, pull tamper-proof means. Such type of cap has disadvantages in that its manufacturing is difficult, that the opening travel is much less than 180°, the quantity of used material is important, since the collar includes, in addition to the fixing skirt, the divergent ledge, and in that the overall dimensions, axially as well as radially, are important.

Document EP-A-0 685 406 discloses a cap having dispensing means including outflow control means and a crown including a hinge, separately manufactured, the means being first inserted into the crown, then the assembly being placed on the container neck. The crown comprises an external skirt for fixing to the neck of the container, a pivotally mounted collar and, on the external skirt, a pull tamper-proof strip and a hinge having a reduced thickness, located substantially in a same transversal plane. In the open position, the lid is located at 90° with respect to the closed position. To hold the open position, the sealing skirt must be long enough to rest on the edge of the dispensing means. The cap has a disadvantage in that the opening travel is limited to 90°, the pulled tamper-proof strip is a waste and creates an unaesthetic empty space, no disc is provided on the dispensing means, and in that it is not possible to make a transparent crown enabling the user to see through the top wall of the crown.

The invention provides a cap with dispensing means which is easy to manufacture, whose opening travel can reach approximately 180°, requiring only a limited quantity of material, having reduced dimensions and generating no waste during the opening, which is aesthetic, and the lid of which can be transparent.

For this purpose and according to a first aspect, the invention provides a cap with dispensing means comprising a first part including dispensing means and the collar having a skirt for fixing to the container body and first rigid fixing means for a second part including a lid having a top wall, a skirt and sealing means for the dispensing means, lid pivoting means and second rigid fixing means complementary to the first rigid fixing means, wherein the pivoting means, positioned transversely at right angle with the lid skirt, include a deformable portion having the general form of a dolly, limited by an upper bent segment having a reduced thickness and belonging the skirt, by a lower bent segment having a reduced thickness and belonging to the second fixing means and by two free flanges having an axial direction, such that during the opening of the cap, the lid pivoting angle can reach approximately 180°.

According to other characteristics of the cap:
the first rigid fixing means, having the shape of an annular groove, are arranged on a shoulder of the lid of the first part and the second rigid fixing means having the shape of a ring belong to the second part, the ring being fixedly held in the groove.
the upper bent segment is located close to the top wall of the collar and the lower bent segment is located close to the shoulder, the deformable portion having the shape of a dolly extending in an axial direction on a total height close to the height of the lid skirt.
on either side of the upper bent segment and on two circular sectors, the free flange of the skirt thus defines a segment oriented towards the top wall, where the axial height of the skirt is reduced, both segments of interest limiting two empty portions.
on either side of the lower bent segment, and on two circular sectors corresponding to the sectors of both above-mentioned segments and both empty portions, the axial height of the ring is increased and forms two triangles, each limited on its bigger length side by an adjacent segment, complementary to the lid segment placed opposite the latter.
on a circular sector slightly bigger than that where the pivoting means and both triangles of the ring are, the outer face of the wall of the dispensing means extends its cylindrical portion by forming a face having the general shape of a cylindrical sector limited downwards by the shoulder of the lid, upwards by a circular sector of the free flange of the dispensing means, and laterally on either side, by a side segment, extending adjacent to the segment corresponding to the lid skirt and to the segment corresponding to the ring triangle, said face forming a counterpart against which the pivoting means and both triangles of the ring are positioned outwards, such that the voids existing around the pivoting means and the triangles are covered up and that any penetration of pollution from the outside into the pouring area is prevented.
from the inner face of the lid top wall protrudes a ledge which is integrally positioned in the axial height of the lid, intended to come into contact with the inner face of the dispensing means wall to participate in the sealing, in addition to the fact that the free flange of the dispensing means comes into contact with the inner face of the lid top wall.

According to one embodiment, the cap also includes external pull tamper-proof means to be torn upon the first opening, in the form of frangible bridges or the equivalent and connecting the free flange of the collar skirt to the opposite and adjacent free flange of the ring.

According to one embodiment, the cap also includes a pull disc which constitutes pull tamper-proof means to be torn upon the first opening, and container content protection means. According to one embodiment, the cap also includes container contents outflow regulating means.

According to another aspect, the invention provides the method for manufacturing a cap such as just described. According to this method, the two cap constituting parts are separately moulded by injection, the second part can be cast in a closed mould, then two parts are rigidly assembled using the first and second fixing means, it being necessary to orient both parts with respect to each other.

In one embodiment, the first part is made of a plastic material such as polyethylene or similar, and the second part is made of a harder plastic material such as polypropylene or similar. The second part can then be transparent.

Other objects and advantages of invention will appear evident from the following description while referring to the appended drawings, among which:

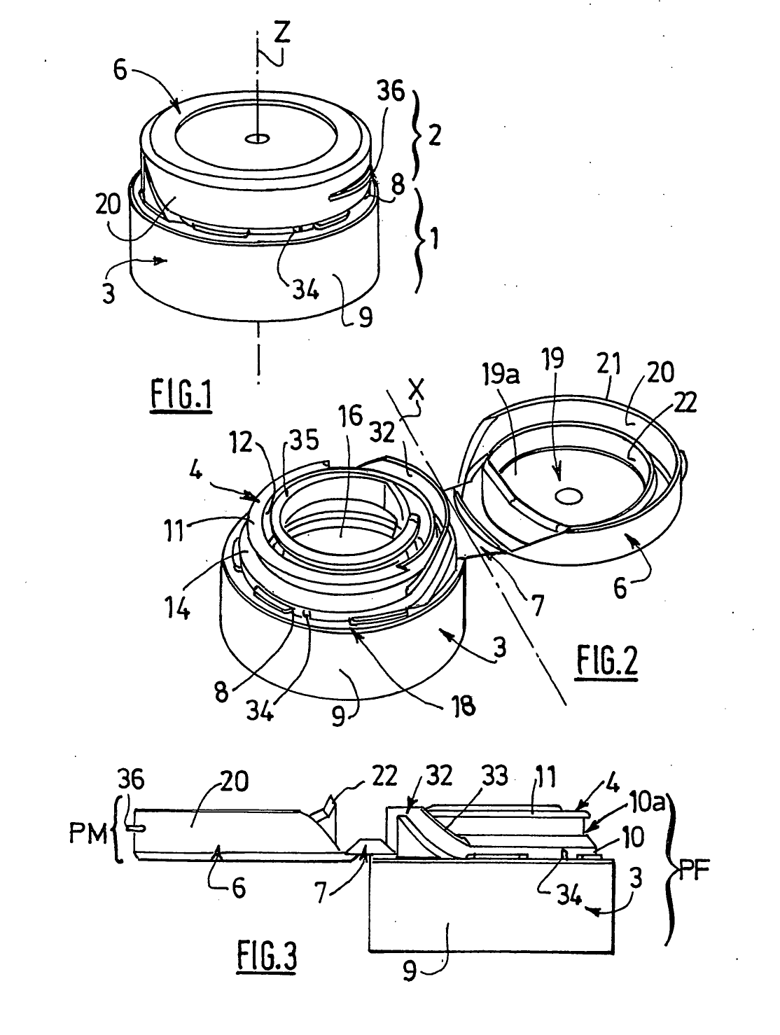

FIG. 1 is a top side view of a cap according to the invention, the collar of which is in closed position;

FIG. 2 is a top side view of the cap of FIG. 1, the collar being in the extreme opening position, after pivoting on approximately 180° with respect to the position in FIG. 1;

FIG. 3 is a side view of the cap of FIG. 2 according to a profile different from that of FIG. 2;

FIG. 4 is a front view of the cap of FIG. 1;

FIG. 5 is a side view of the cap of FIG. 1;

FIG. 6 only shows the collar of the cap shown in FIG. 4, on a front view;

FIG. 7 only shows the collar of the cap shown in FIG. 5, on a side view;

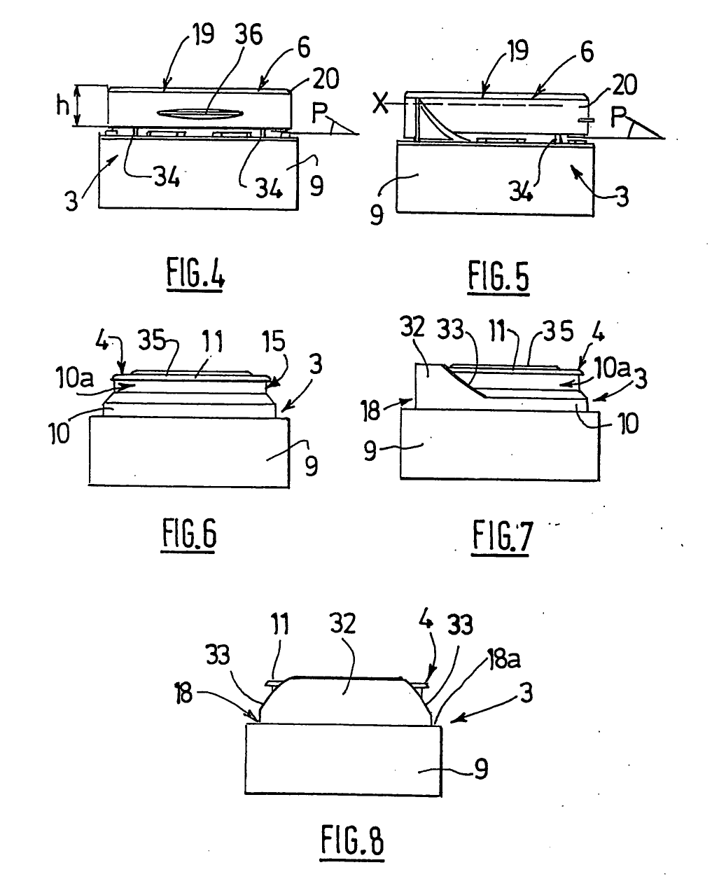

FIG. 8 shows the collar of the cap on a back view;

FIG. 9 is a top side view of the collar turned upside down;

FIG. 10 is a top side view of the collar;

FIG. 11 is a front view of the lid prior to a first opening of the collar;

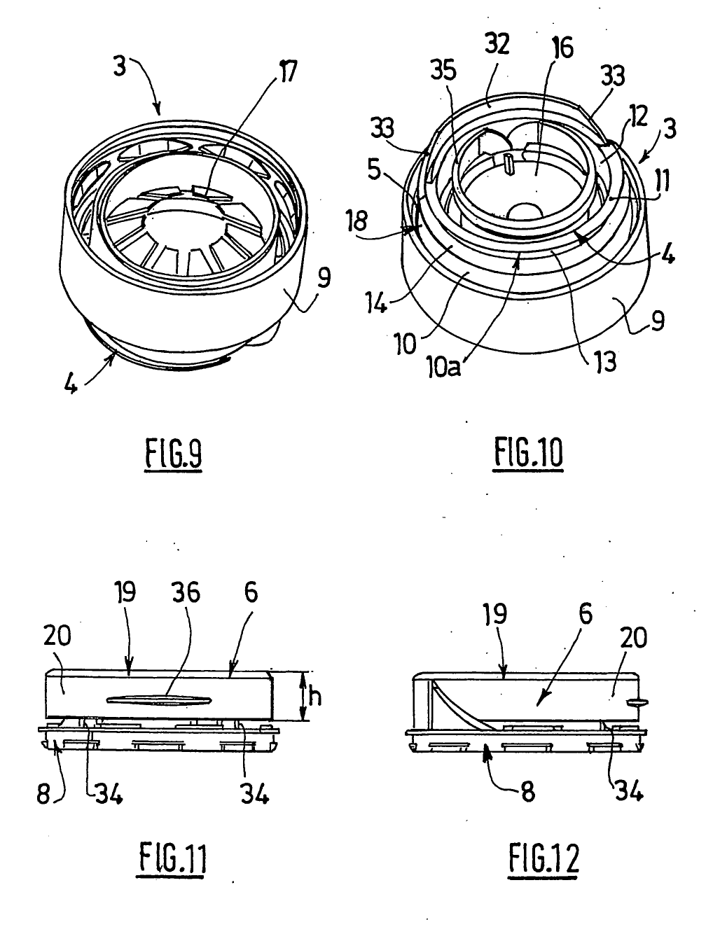

FIG. 12 is a side view of the collar prior to a first opening of the collar;

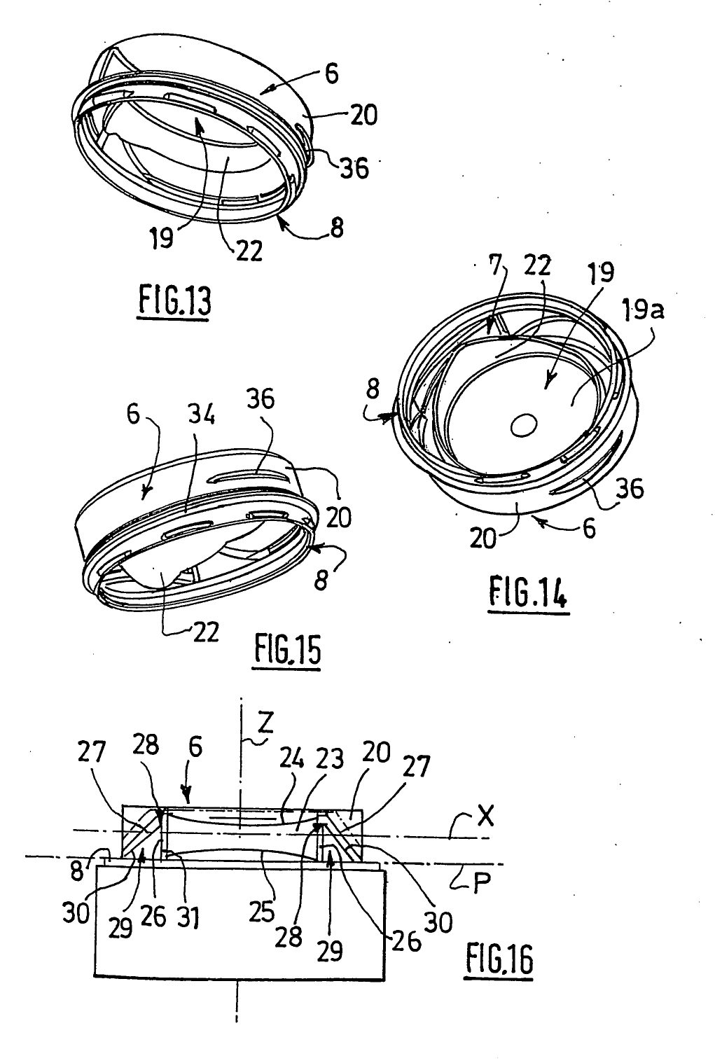

FIGS. 13 to 15 show the inside of the lid prior to a first opening, from various angles;

and FIG. 16 is a back view of the cap illustrated in FIG. 1.

The cap with dispensing means, made of a plastic material and having a general revolution axis Z is typically intended for containers (such as bottles) for packaging a liquid or pasty content and more particularly a food product such as oil, sauce, vinegar, dairy or any other product.

In the embodiment shown, the cap comprises a first part 1 and a second part 2, rigidly associated to each other.

The first part 1—for example made of polyethylene—forms a peripheral collar 3 and dispensing means 4. It also includes first peripheral fixing means 5 for the second part 2.

The second part 2—for example made of transparent polypropylene—forms a lid 6, lid 6 pivoting means 7 and second peripheral fixing means 8 complementary to the first fixing means 5.

The cap is described while assuming that the axis Z is vertical, the collar 3 is oriented downwards and the lid 6 upwards. The words “high”, “low”, “above”, “under”, “top” must be understood with respect to this position. The word “axial” refers to the axis Z, whereas the word “transversal” concerns something perpendicular to the axis Z. Depending on the context, the word “internal” (or “inner”) relates to what is located in the cap, stricto sensu, or what is oriented towards, or close to the axis Z, whereas the word “external” (or “outer”) relates to the contrary. Except otherwise mentioned, the cap is described in the closed position, prior to its first use.

The lid 3 includes an external skirt 9 having a general cylindrical form, oriented downwards, arranged and intended for being fixed on the neck of the container through appropriate fixing means complementary to each other, such as a protruding ledge or a thread provided on the inner face of the external skirt 9.

The dispensing means 4 include a cylindrical wall 10 having a diameter smaller than that of the external skirt 9, having a portion opposite the external skirt 9 and a portion 10a axially protruding upwards from the external skirt 9. Such 10a portion is limited at its top end by a free flange 11 which substantially extends in a transversal plane. The free flange 11 is flared outwards to form a dispending means on a bit more than the semi-circle opposite the pivoting means 7.

The portion 10a of the wall 10 has a smooth cylindrical inner face 12 and an outer face 13 having a cylindrical portion 14 downwards, on the external skirt 9 side, and upwards a hollow portion 15 having a smaller diameter and connecting the cylindrical portion 14 to the free flange 11.

In the embodiment shown, the dispensing means 4 also include, on the one hand, a disc 16 which prevents access to the content on the container prior to a first use, and which protects such content, and on the other hand, container content outflow regulating means 17.

The lid 3 also has an annular shoulder 18, which is transversal and located between the top of the external skirt 9 of the collar 3 and the portion 10a of wall 10 of the dispensing means 4. The annular shoulder 18 has a top face 18a in which an annular groove having an axial direction is arranged, opening upwards and joined to the outer face of the cylindrical portion 14 of the wall 10. Such groove forms the first fixing means 5.

The lid 6 includes a transversal top wall 19—which is plane in the embodiment shown—having an inner face 19a turned downwards. It also includes a short cylindrical peripheral skirt 20 which is joined to the peripheral edge of the wall 19, and which is limited by a lower free flange 21. The skirt 20, and thus the whole lid 6, has an axial height h which, thanks to the structure of the cap, can be reduced without modifying the other parts. For example, for a cap the collar of which has a diameter of the order of 3 cm and a total height of the order of 1.5 to 2 cm, the height h can be of the order of 0.5 cm.

From the inner face 19a of the top wall 19 of the lid 6 protrudes downwards a collar 22 having a general cylindrical form, and entirely located in the axial height on the lid 6 defined by the height h of the skirt 20. In the embodiment shown, the axial height of the ledge 22 is approximately a little bit more than half, or approximately two thirds of the height of the skirt 20. However, the ledge 22 does not protrude below the transversal plane defined by the lower free flange edge 21 of the skirt 20. The ledge 22 which has an external diameter corresponding to the internal diameter of the portion 10a of the wall 10 towards the free flange 11, comes into contact with the inner face 12 of the wall 10 to participate in the sealing, in addition to the fact that the free flange 11 of the dispensing means 4 comes into contact with the inner face 19a of the top wall 19 of the lid 6.

The second part 2 also includes a ring forming the second peripheral fixing means 8. The ring 8 is press-fitted and fixedly held in the groove 5 thanks to appropriate respective protrusions or by welding or by any other means. Both parts 1 and 2 are thus rigidly associated together. In the embodiment of interest, the ring 8 includes an upper horizontal, radially oriented outwards, lug which comes onto the upper face 18a of the annular shoulder 18, just above the external skirt 9 of the collar 3, so as to totally close the groove 5.

It should be understood that the groove 5 and the ring 8 can be the object of alternative embodiments which remain within the scope of the patent, as long as the rigid cooperation function providing the respective fixing of both parts 1 and 2 is fulfilled. It should also be understood that equivalent means can be substituted for the groove 5 and the ring 8.

The cap composed of two parts 1 and 2 includes two portions, one that can be called a fixed portion PF—because it is rigidly fixed on the container neck—and the other portion which can be called a mobile portion PM, associated together by the pivoting means 7. The fixed portion PM includes the first part 1 and ring 8, whereas the mobile portion PM is only composed of the lid 6.

Both fixed PF and mobile PM portions first cooperate as described, in that the inner face 19a of the top wall 19 and the outer face of the ledge 22 of the collar 6 come into contact, respectively, with the free flange 11′ and the inner face 12 of the wall 10 of the dispensing means 4 for participating in the sealing. Then, the cylindrical peripheral skirt 20 encloses the portion 10a of the wall 10 on the outside. The portion of the inner face of the skirt 20 of the lid 6 adjacent to its lower free flange 21 comes into contact with the outer face 13 of the cylindrical portion 14 of the wall 10 of the dispensing means 4, in order to help holding the cap in the closed position. Except for a circular sector in which the pivoting means 7 are, the free flange 21 of the skirt 20 is adjacent to the upper edge of the ring 8, substantially in the transversal plane of the shoulder 18 hereinafter called the junction plane P, because when you look at the cap from the outside, the plane P is that in which the lid 6 and the collar 3 appear to be adjacent.

The pivoting means 7 functionally associated with the fixed portion PF and the lid 6 provide the pivoting of the latter around a transversal axis X between two extreme positions, i.e. a stable closed position (FIGS. 1, 5 and 6) and a stable open position (FIGS. 3 and 4). The extreme open position results from the pivoting of substantially 180° with respect to the closed position. If need be, the lid 6 can be opened in an intermediate position, for example after having pivoted on 90° (FIG. 2). The axis X is essentially virtual and its position is not perfectly fixed but, on the contrary, is moved axially during the opening and the closing of the cap.

In the particular embodiment shown, the pivoting means 7 comprise a deformable portion 23 having the general form of a dolly, having a transversal axis parallel to the axis X. The deformable portion 23 is limited upwards by an upper bent segment having a reduced thickness 24 and forming a deformable area having a lower resistance, belonging to the skirt 20 of the lid 6 (the mobile portion PM). The deformable portion 23 is limited downwards by a lower bent segment having a reduced thickness 25 and forming a deformable area having a lower resistance, belonging to the ring 8 (the fixed portion PF). Laterally, on either side, the deformable portion 23 is limited at its transversal ends by two free flanges 26 which are straight and have an axial direction.

During the motion of the opening of the lid 6 from its closed position, the pivoting axis X is first situated on the point at or in the vicinity of the upper bent segment 24. At this moment, the ledge 22 having a small axial length can fall from the wall 10. Then, the deformable portion 23 having the shape of a dolly is deformed and bent outwards. For the completion of the opening motion, the pivoting axis X is at or close to the lower bent segment 25. Thus, during the opening motion, the pivoting axis X is generally moved downwards. In the total open position on 180°, the deformable portion 23 having a general shape of a dolly is slightly curved with a concavity oriented downwards and is substantially located in the transversal plane close to the plane of the top wall 19 of the lid 6.

On either side of the upper bent segment 24 and on two small circular sectors—i.e. a few degrees or a few dozen degrees—, the lower free flange 21 of the skirt 20 of the lid 6 defines a segment 27 oriented towards the top wall 19 and extending to be close to the latter. In the embodiment shown, the two segments 27 have, each, a very slightly rounded general shape and their connections with the rest of the free flange 21 of the skirt 20 and with the upper bent segment 24 are also rounded. Thus, at the segments 27, the axial height of the skirt 20 is reduced and both segments 27 define two empty portions 28.

On either side of the lower bent segment 25 and on two small circular sectors corresponding to the sectors of both segments 27 and both empty portions 28, the axial height of the ring 8 is increased, the ring 8 protruding axially outwards and above the groove 5, so as to form a kind of curvilinear right-angled triangle 29. Such a curvilinear right-angled triangle 29 is limited on its bigger length side opposite the right-angle by a segment 30, adjacent and complementary to segment 27 placed opposite the latter. On a second smaller length side, the curvilinear triangle 29 is limited by a straight edge 31, having a general axial direction, adjacent to the free flange of the end 26 of the deformable portion 23. The third side of the curvilinear triangle 29 corresponds to the extension of the main portion of the ring 8. The two enlarged areas of the ring 8 in the form of a curvilinear triangle 29 are accommodated in a complementary way in the two empty portions 28.

The upper bent segment 24 is positioned close to—more particularly very close to—the top wall 19 of the lid 6 and the lower bent segment 25 is located close to—particularly very close to—the annular shoulder 18. Thus, the deformable portion 23 having the shape of a dolly, extends in the axial direction on the total height of approximately the height h of the skirt 20. As the lower bent segment 25 is located substantially in the junction plane P, the whole pivoting means 7 are substantially located between the plane defined by the top wall 19 of the lid 6 and the junction plane P. The cap has thus a limited axial height and made with a lower quantity of plastic material.

Thanks to the two axial slots existing on either side of the pivoting means 7, each defined by a free flange 26 of the deformable portion 23 and the flange 31 opposite the curvilinear triangle 29, the portion 23 having the shape of a dolly can be deformed while bending outwards and, in the total opening position, be substantially located in or close to a transversal plane adjacent to the plane of the top wall 19.

On a circular sector which is slightly bigger than that where the pivoting means 7 and the two curvilinear triangles 29 of the ring 8 are positioned, the outer face of the wall 10 of the dispensing means 4 has no hollow portion such as 15 and on the contrary extends the cylindrical portion 14 to form a face 32 having the general shape of a cylindrical sector. The face 32 is limited downwards by the shoulder 18 and upwards by a circular sector—i.e. of the order of 90°—of the free flange 11.

The face 32 is laterally limited, on either side, by a side segment 33 which is slightly bent and extends in an adjacent way to the segment 27 of the skirt 20 and to the segment 30 of the curvilinear triangle 29 of the ring 8.

The face 32 is a counterpart against which the pivoting means and the two curvilinear triangles 29 are positioned outwards. Thus, the voids existing around the pivoting means 7 and the curvilinear triangles 29 are covered up and the penetration of pollution from the outside into the pouring area is prevented.

According to a possible embodiment, the cap also includes external pull tamper-proof means 34 to be torn upon the first opening, interposed between the fixed portion PF and the mobile portion PM. Such means 34 are in the form of frangible bridges connecting the lower free flange 21 of the skirt 20 to the upper flange opposite and adjacent to the ring 8. The frangible bridges 34 are designed to be broken when, upon the first opening of the lid 6, the user axially pulls the lid 6 upwards, opposite the pivoting means 7. According to another alternative embodiment, the frangible bridges 34 can be substituted by a line or a zone having a lower resistance. It should be noted that such embodiment is tamper-proof to be torn upon the first opening, and generates no waste upon such first opening.

If need be, as an alternative or supplementary embodiment, the external pull tamper-proof means to be torn upon the first opening, are a sleeve or a sheath made of a plastic film enclosing the collar 3 and the lid 6.

In a possible and shown embodiment, the cap also includes the pull disc 16 which constitutes internal pull tamper-proof means to be torn upon the first opening. As the lid is transparent, as mentioned above, the user can see that the disc 16 is in position and has not been removed

The disc 16 is constituted by a transversal removable bottom which closes the dispensing means 4, the peripheral edge of which is connected to the inner face 12 of the wall 10 of the dispensing means 4, above the regulating means 17, here in a plane positioned slightly under plane P, by a line or a zone having a lower resistance, so that it can be torn after a sufficient pulling by the user, once the lid 6 has been opened and removed. Above the disc 16 is fixed a gripping ring 35 which facilitates the pulling of the disc 16 by the user.

In the embodiment shown, the container contents outflow regulating means 17 are constituted by multiple portions (currently called “petals”) extending from the inner face 12 of the wall 10 of the dispensing means 4, slightly under the disc 16, and oriented towards the axis Z, substantially uniformly distributed about said axis, slightly oriented downwards and leaving passage spaces between them and in the centre.

In the embodiment shown, the lid 6 includes, on the outer face of its skirt 20, diametrically opposite the pivoting means 7, a small protrusion 36 oriented transversely outwards and giving a grip to the user so as to facilitate the opening of the lid 6.

For manufacturing the cap, both parts 1 and 2 are separately moulded by injection—the second part 2 can be cast in a closed mould—then two parts 1 and 2 are rigidly assembled together by fitting or welding or by any other means. The cap thus manufactured can be mounted on a container once it is filled. It should be noted that, in the described embodiment, it is necessary to orient both parts 1 and 2 about the axis Z to assemble them, to make the pivoting means 7 of the part 1 and both curvilinear triangles 29 coincide with the cylindrical sector 32 of the part 2.

1. A cap comprising:
a first part, including a dispenser and a collar, having a skirt for fixing to a container body and a first rigid fixing member for a second part, including a lid having a top wall, a skirt and a seal for the dispenser, a lid pivot and a second rigid fixing member, complementary to the first rigid fixing member;
the first rigid fixing member, in the shape of an annular groove, being arranged on a shoulder of the collar of the first part and by the second rigid fixing member, in the shape of a ring, integral with the second part, the ring being fixedly held in the groove;
the pivot being located transversely, at a right angle with the skirt of the lid, including a deformable portion having the general shape of a dolly, limited by an upper bent segment having a reduced thickness and belonging to the skirt, by a lower bent segment located close to the shoulder, having a reduced thickness and belonging to the second fixing member, and by two free flanges having an axial direction, such that upon the opening of the cap, the collar pivoting angle can reach approximately 180°.

2. The cap according to claim 1, wherein the upper bent segment is positioned close to the top wall of the lid and the deformable portion has the shape of dolly and extending in an axial direction on a total height of the order of the height of the skirt of the lid.

3. The cap according to claim 1, wherein on either side of the upper bent segment and on two circular sectors, a free flange of the skirt defines a segment oriented towards the top wall, where the axial height of the skirts is reduced, both segments limiting two empty portions.

4. The cap according to claim 1, wherein on either side of the lower bent segment and on two circular sectors corresponding to the sectors of both segments and both empty portions, the axial height of the ring, is increased and forms two triangles, each limited on its first bigger length side by a segment, adjacent and complementary to a segment placed opposite the latter.

5. The cap according to claim 1 further comprising a circular sector being slightly bigger than the one where the pivot and both triangles of the ring, are positioned, the outer face of a wall of the dispenser extends the cylindrical portion, forming a face having the general shape of a cylindrical sector limited downwards by the shoulder and upwards by a circular sector of a free flange and laterally on either side by a side segment, extending adjacent to the segment of the skirt and to the segment of the triangle of the ring, the face forming a counterpart against which the pivot and both curvilinear triangles are positioned, outwards, such that voids existing around the pivot and the triangles are covered up and that the penetration of pollution from the outside towards the pouring area is prevented.

6. The cap according to claim 1, further comprising a pull tamper-proof device being torn upon the first opening, in the form of frangible bridges or an equivalent, connecting a lower free flange of the skirt of the lid to the upper flange opposite and adjacent to the ring.

7. The cap according to claim 1 further comprising a pull disc which is internally pull tamper-proof to be torn upon the first opening, and a container content protector.

8. The cap according to claim 1 further comprising a container content outflow regulator.

9. The cap according to claim 1 further comprising a ledge which is integrally positioned in the axial height of the lid, protruding from an inner face of the top wall of the lid, the ledge being intended to come into contact with the inner face of the wall, participates in the sealing, in addition to the fact that the free flange of the dispenser comes into contact with the inner face of the top wall of the lid.

10. The method for manufacturing a cap according to claim 1, wherein both parts are separately moulded by injection, the second part is cast in a closed mould, then both parts are rigidly assembled together using the first and second fixing members, without it being necessary to orient both parts with respect to each other.

11. The cap according to claim 10, wherein the first part is made of a plastic material such as polyethylene or similar, and the second part is made of a harder plastic material, such as transparent polypropylene or a similar.
